(19) United States
(12) Patent Application Publication
(10) Pub. No.: US 2007/0060034 A1
(43) Pub. Date: Mar. 15, 2007

(54) Gaming machine smoke control systems and processes

(76) Inventor: Thomas Tanner, Colts Neck, NJ (US)

Correspondence Address: Eugene Berman;Law Offices of Eugene Berman, 26 Cedarwood Court, Rockville, MD, 20852, US

(21) Appl. No.: 11/519,158

(22) Filed: Sep. 11, 2006

Related U.S. Application Data
(60) Provisional application No. 60/716,251, filed on Sep. 13, 2005.

(51) Int. Cl. B08B 15/02; A63F 13/02; A63F 9/00

(52) U.S. Cl. 454/63; 273/148 R; 273/148 B

(57) ABSTRACT

Smoke control systems and processes for controlling tobacco smoke in areas near a slot machine and similar gaming machines, in which the smoke control system is associated with the gaming machine.

### CROSS-REFERENCE TO RELATED APPLICATIONS

This application claims the benefit of U.S. Provisional Application No. 60/716,251, filed Sep. 13, 2005.

### BACKGROUND OF THE INVENTION

This invention relates to smoke control systems and processes. More particularly, the invention relates to smoke control systems and processes for controlling tobacco smoke in the ambient air near a slot machine and similar gaming machines wherein the smoke control system is associated with the gaming machine.

Environmental tobacco smoke (ETS), which is also commonly referred to as second hand smoke, is smoke from the use of tobacco products such as cigarettes, cigars and pipes. Since use of cigarette is more widespread than cigars or pipes, for convenience the term cigarettes will be used herein to refer all of these tobacco products. ETS is composed of more than 3800 different chemical compounds and is of considerable health and social responsibility concern. ETS is comprised of both particulates and gas-phase contaminants. The particulate contaminants in ETS are, in significant part, very small solids and liquid substances (e.g., tars) that are light enough to be entrained in the air and are of respirable-size which have a higher probability of penetrating deep into human lungs. In addition to size considerations, the particulates are composed of diverse organic and inorganic material. The gas-phase contaminants in ETS include a wide array of combustion gases and other organic chemicals, which pose additional complexity and concerns. Optimal removal of tobacco smoke from ambient air requires the removal of both particulates and gas-phase contaminants.

Enclosed areas where large numbers of people gather such as restaurants, offices, waiting rooms and auditoriums, often contain sizable filtration and/or ventilation systems to remove ETS and other contaminants from the ambient air. Many such establishments place their filtering systems in a remote region of a room where contaminated air tends to accumulate. These systems usually draw the contaminated air from the room and filter the air or vent it through an outlet while replacing it with filtered air or with fresh air from outside the room. Large air filtration and/or ventilation systems have found wide spread use in an effort to significantly reducing the concentration of noxious substances in a sizable region, in conjunction with general heating and cooling equipment. However, because these large systems must usually be placed at a remote location away from the usual sources of the contamination, e.g., near the ceiling at the center or a corner of a room, they often do not keep the ambient air sufficiently free of noxious substances, particularly in areas wherein the contaminants are introduced.

Relatively small air filtration units, which purify air close to a contamination source, may be useful by individuals in minimizing their exposure to noxious substances at some specific locations. Although small air filtration units have served some limited purposes, they do not provide entirely satisfactory service for a number of technical and/or practical reasons. Such air filtration units often do not have sufficient contaminant removal capacity, are noisy, consume significant power, are difficult to inspect and service, are not designed for ease of use and/or do not efficiently remove the contaminants at the source. Additionally, there are practical implementation obstacles resulting from the lack of acceptance and/or individuals failure to utilize, maintain or activate them.

ETS is a particularly important issue in the gaming industry, since the great popularity of gaming machines have resulted in very large number of these gaming machines being used in casinos, often with a large number of these devices being configured in very close proximity. In casino applications, due to the large number of users who smoke tobacco during use, a large amount of ETS is produced from numerous diverse points of emission. The gaming environment is designed to be comfortable for the user, with various components of environmental quality (including temperature, air quality, noise level, etc.) each being important (e.g.; extensive filtration of the air may beneficially reduce the level of contaminants in the air but may be unacceptable from a noise level or air movement standpoint).

ETS is not only important from a health, comfort and regulatory perspective in view of the impact upon persons using gaming machines, but it is also a significant concern to the function of the machine per se. Most modern gaming machines contain electronic components which requires cooling thereof and this is commonly accomplish by providing for the passage of ambient air through the interior of the machines (e.g.; by an internal fan and associated vents in the exterior of the machine which allows for ambient air to flow in the interior regions for which cooling is desired). However, the presence of ETS in the introduced ambient air can harm the electronic components and require extra maintenance.

Though some prior attempts to deal with the foregoing problems appeared to be technically possible and/or may appear to been suitable, the known technologies and systems used do not provide for removal of tobacco smoke from ambient air in gaming machine applications in a practical and efficient manner in view of the spatial constraints, power considerations, noise constraints and maintenance considerations. Even assuming that the technical challenges were met, equally important consumer acceptance considerations and ease of use challenges exist, particularly by smokers who may have lesser concerns about ETS or their actions in contributing to ETS, and would be less likely to utilize available means, if any effort on their part was needed to do so.

### BRIEF DESCRIPTION OF THE INVENTION

The invention provides systems for controlling tobacco smoke in association with a gaming machine which includes an exhaust fan having an inflow zone for allowing the flow of air from a region typically occupied by a user of said gaming machine, an outflow zone from the exhaust fan, an ashtray region which is sufficiently close to said inflow zone to allow a substantial portion of smoke emanating from a burning cigarette placed in said ashtray region to flow directly into said inflow zone and filtering means between said inflow zone and said outflow zone.

The invention also provides systems for controlling tobacco smoke in association with a gaming machines by exhausting contaminated air from the ambient air in front of said gaming machine which is typically occupied by a user of the gaming machine and an ash tray for lighted cigarettes, which includes an exhaust fan having filtering means and functionally associated with the gaming machine, an inflow zone exhausting ambient air adjacent to the front of the gaming machine into said exhaust fan; an outflow zone through which air filtered through said filtering means is passed; means for detecting when the gaming machine is in use and means for automatically activating said exhaust fan in response to a signal indicating use from said detecting device that the gaming machine is in use.

The present invention also provides methods of controlling tobacco smoke in association with a gaming machines in the region surrounding the gaming machine in which a player would be present including: (1) automatically actuating an exhaust fan functionally associated with the gaming machine when said device is in use, (2) withdrawing air from a region surrounding the gaming machine through a permanent electrostatic filter within the exhaust fan; and (3) exhausting said air after passage through said filter.

### BRIEF DESCRIPTION OF THE DRAWINGS

FIG. 1 is a perspective view of a smoke removal system of the present invention designed for incorporation into the coin catch portion of a gaming machine.

FIG. 2 is a perspective view of another smoke removal system embodiment designed for incorporation into the coin tray portion of a gaming machine.

FIG. 3 is a perspective view of a smoke removal system embodiment similar (but not identical to) that shown in FIG. 2, which depicts one way of mounting of an exhaust fan in a suitable housing.

FIG. 4 is a perspective view of another smoke removal system embodiment designed for attachment to the side of a gaming machine or positioning in between two adjacently placed gaming machines, with the smoke removal system optionally being pivotable.

### DETAILED DESCRIPTION OF THE INVENTION

The smoke control systems and processes for controlling tobacco smoke of the present invention are useful with all types of gaming machines. Gaming machines, including slot machines which are the most common form, exist in various forms and are know by various names including one-armed bandits, straight up slots, slant top slots, jackpot machines, blackjack machines, pachinko machines, etc.

In using a gaming machine, a user typically risks a sum of money or something else of value, on the outcome of the game or other event, which the machine displays, in the hope of winning. Such devices were originally mechanical reel devices into which a user inserted a coin and activated a lever, for a gaming purpose. These devices are commonly referred to as one-armed bandits, with the goal of the game is to spin the reels so that the symbols on all reels line up on the pay line in a winning combination. More modem versions are electromechanical devices, many of which have sophisticated electronics, and which a player utilizes by inserting paper currency, a card or other monetary equivalent medium, for the gaming purpose, but with no coins being used. The industry refers to the new slot machines as an Electronic Gaming machine (EGD) or a Video Gaming machine (VGD), with most new machines are equipped with a bill receptor to accept paper money and/or a coin less system that pays out a voucher instead of coins. Older “coin” type slot machines are frequently retrofitted to be cash-less machines, which eliminates the need for the existing coin trays or coin catch hoppers.

The smoke control systems of the present invention are used in association with gaming machines. The term association as used herein means that the smoke control system and the gaming machine are (1) structurally incorporated, for example by having the entire smoke control system being integrally incorporated into the gaming machine itself; (2) electrically connected by having wiring between the smoke control system and the gaming machine (e.g.; an electrical connection from a sensing device on the smoke control system to activate the smoke control system when the gaming machine is in use, as described below); (3) mechanically connected (e.g.; by having a conduit carrying filtered air from the smoke control system into the interior of the gaming machine to provide cooling, as also described below); and/or (4) having the smoke control system and the gaming machine being appropriately spatially positioned in such close proximity to the region in which smoke is produced by a smoker using the gaming machine, that such smoke can be effectively drawn into the smoke control system.

The exhaust fans used in accordance with this invention should be of sufficient capacity to exhaust the smoke contaminated air from the region immediately adjacent to the front of the gaming machine (i.e.; the region in which a lighted cigarette would be placed and the area in which the user of the machine who would be smoking would sit or stand), yet not create either an amount of draw of air or exhaust of air of such velocity and volume as to undesirably impact the user (e.g.; ideally the user would not feel or hear the exhaust fan's operation). Most typically, the exhaust fans are driven by an electrical motor using the same power supply as the gaming machine uses. Example of a suitable fans include (1) an axial cooling fan, Model No. 4715FS-12-B50, 115 v, 17 watts, 205 amps, 3300 rpm, 56 dBA, 110 cfm made and (2) 4100 N Series Tubeaxial fan, each made by EBM-PAPST, Inc. which have various models with dBA rating between 44 and 65 and cfm capacities of between 94 and 180). Other exhaust fan suitable for this purpose will be apparent to those skilled in the art.

In the selection of optimal fans in the practice of the present invention, the distance from the intake to the fan to the region in which smoke from the contaminant sources is important. For example, when a lighted cigarette in an ashtray is placed approximately 3-4 inches or less from the intake of an EBM-PAPST, Inc. Model 4114HN3 fan rated as 160 cfm, essentially the entire visible plume of smoke from the cigarette is seen flowing in a straight path toward the fan intake. As the ash tray/lighted cigarette is moved to 6 inches away from the fan, the plume is seen to rise and form an arc-like somewhat diffuse stream toward the fan's intake, with the stream containing the vast majority of the smoke from the cigarette. As the ash tray/lighted cigarette is moved to about 8 inches from the fan, the plume is seen to rise vertically and diffuse in the surrounding air, with the fan seemingly having little or nor impact in capturing portions of the plume. When an otherwise similar fan, but with a 180 cfm capacity, is used, smoke can effectively be captured from a lighted cigarette approximately 8 inches from the fan.

A variety of means may be employed to automatically actuate an exhaust fan functionally associated with the gaming machine when said device is in use [including actuating the system upon the initiation of use and the cessation of operation of the system upon termination of use or at a predetermined time (e.g.; 5 minutes) thereafter]. For example, the exhaust fan can be electrically activating in response to the initiation of use of the gaming machine by a player (e.g.; in response to the insertion of the coin or ticket used to play the device). Additional examples include (i) a sensing means (e.g.; an electric eye or motion detector) may be used detecting the presence of a potential player at a predetermined position near the gaming machine, (ii) a smoke detector which would detect when the level of smoke in the area in front of the gaming machine exceeded a predetermined concentration (e.g.; above “normal” background levels, to indicate that a user of the gaming machine is smoking). As shown in the Figures (discussed hereinafter) one or more automatic actuation means (e.g.; motion detector) or sensing means is mounted on top of the exhaust fan housing of a system incorporated in the coin catch of a slot machine. When a user approaches the machine, the user presence is detected and the fan is activated (via an electrically activated switch, not shown). When the user ceases to be present, the fan is shut down either immediately or after a predetermined period of time after the presence of the user is no longer detected. One or more of additional sensing means could also be used to sense and indicate when the filter needs to be changed (e.g.; based upon a pressure drop measurement across the filter and a predetermined setting indicating when the pressure drop is unacceptable) and/or when a removable ashtray needs to be emptied (e.g.; based upon the reading of a load cell under the ashtray

Filters suitable for use in the present invention should be selected to assure that the appropriate level of contaminant removal is achieved in a practical and efficient manner in view of the spatial constraints and consumer acceptance consideration. Air cleaners (which is the term commonly used when the principle function of the device is particulate removal) are usually classified by the method employed to remove the particulate, namely: mechanical filters, electronic air cleaners, ion generators and/or “hybrid” combinations utilizing one or more of these methods. For example, mechanical filters are typically filters which consist of a low packing density coarse glass fibers, vegetable fibers etc., often coated with a viscous substance to act as an adhesive for particulate material or flat filters made of “electret” media consisting of permanently charged plastic film or fiber. Electronic air cleaners (often called electrostatic precipitators or charged media-media filters) use an electric field to trap charged particles. Ion generators also use static charge to remove particles by adding charge to the particles.

The performance of air cleaners in removing particulates depends on a number of factors including the (1) volume of air flow through cleaner, (2) the efficiency of the particulate capture mechanism, (3) the degradation rate of the capture efficiency caused by loading, (4) the mass of particles entering the device, (5) the characteristics of the particles (e.g.; size and whether they are liquid or solid), and (6) the amount of entering air which by-passes the capture mechanism. There are various methods to measure performance, such as the weight arrestance test described in ASHRAE Standard 52-76, Military Standard 2823, etc.

Removal devices for gaseous pollutants typically rely on solid sorbents (e.g.; activated carbon). The performance of solid sorbents depends on a number of factors including the air flow rate through the sorbent, the concentration of pollutants, the presence of other gases or vapors (e.g.; humidity), the physical and chemical characteristics of both the pollutants and the sorbent (e.g.; weight, polarity, size, shape), the configuration of the sorbent in the device, the quantity of sorbent used and the sorbent bed depth and the amount of entering air which bypasses the capture mechanism. Filters may also be used to provide a scent to the filtered air, (e.g.; by coating the filter with a material such as ellagic acid, which neutralizes and/or dissolves some of the odorous contaminants

In the consideration of seemingly suitable filters for use in a gaming machine environment, no single existing device or media was found to be sufficient to efficiently achieve the desired cleansing of the air yet satisfy the above constraints and other considerations. Instead, it was determined that a unique filtration approach and positioning, in conjunction with the other aspects of the present invention was required.

In accordance with the present invention, most of the above filtration-related constraints could be met and other considerations satisfied if the filter used in the smoke removal system of the present invention is a composite filter including both an electrostatically charged filter (e.g.; a Electrostat® filter media as commercially provided by Ahlstrom) and a fibrous filter. In one preferred embodiment of this invention, a multiple layer filter would be used further comprising:

(1) a 150 g/m2 permanent electrostatically charged filter media as a prefilter with a 0.1 NaCl efficiency of>95% at 32 LPM a delta P<0.6 mm and an air perm>200 CFM, and

(2) a carbon filter with high gaseous adsorbent capacity with a composition of activated carbon, synthetic fibers, cellulose and a binder with a mass of 0.5 um and an air perm of 2400 L/m2/s at 200 kPa, and

(3) a 250 g/m2 polishing filter of permanently electrostatically charged media with a 0.1 NaCl efficiency of>99% at 32LPM, a delta P<1.2 mm and an air perm>100CFM.

To assure proper maintenance of the exhaust fan and filter replacement, the design of the system preferably should enable ease of maintenance, for example, including detection means (e.g.; a pressure drop measurement means to detect excessive buildup of deposits on the filter or filters) and appropriate design of the exhaust fan housing and filter compartment to allow easy assess for filter inspection, cleaning and/or replacement (e.g.; as depicted in the figures, discussed hereinafter).

The environment in which the device is or must be located poses additional challenges and constraints. In the areas surrounding a slot machine or other similar gambling machine, the challenges of effectively dealing with ETS are particularly daunting due to the multiple and changing sources of the smoke (e.g.; as patrons come and go from a given machine and adjacent machines), constraints in the permissible size of any ETS capture device, where the device needs to be located, the permissible or desired direction of exhaust streams, acceptable noise generation, acceptable power consumption, aesthetics, cost considerations, etc.

Although the filtration means as previously described is an important feature of the present invention, the positioning of the intake of filtration device [with respect to the region in which the user of the gaming machine would likely be present and the region in which the lighted cigarette would be placed (e.g.; a ash tray) when the user is not drawing smoke from the cigarette] is of equal if not of greater importance. It has been estimated that about 80% of the contaminated air from cigarette smoking in a gaming casino environment comes directly from the burning cigarette and the remaining 20% comes principally from the smoker's exhaled air. Accordingly, it is an important to capture contaminated smoke both directly from the burning cigarette and the air exhaled by the smoker. The present invention addresses this by assuring that the air intake of the system is sufficiently associated with the gaming machine to focus on the region that a smoker using the gaming and his/her cigarette would be. As described in greater detailed elsewhere herein, the type of association can be (1) having the smoke removal system be integrated into or connected to the gaming machine itself or (2) otherwise being closely associated with it spatially, but not an integral part of the gaming machine (e.g.; being connected to the side of the gaming machine and placed in between two adjacently positioned gaming machines). Since as previously described, many gaming machines were originally designed to be coin operated have be retrofitted to accept paper currency or tickets), placing the smoke removal system in the portion of the gaming machine in which a coin tray or coin catch was originally or would be other wise be present, is particularly advantageous for both functional and aesthetic reasons.

The ambient contaminated air after being passing through the filtering means of the present invention has reduced contaminant levels compared to the contaminant levels in the intake flow, with the amount of reduction being determined by the incoming contaminant levels, the filtration media employed, flow rates and other factors. The present invention provides for a variety of uses or outputs for the filtered air. Depending on the application and the preferences of the operator of the venue in which the units are installed, the output air can be directed (1) back toward the smoker (providing cleaner air than that which might otherwise be surrounding the smoker), (2) away from the smoker into the general room environment (providing a lower contaminant loading into general room environment than that which would result from un-captured smoke from burning cigarettes and smokers' exhalation) or (3) into the interior of the gaming machine for reasons discussed below. For example, if operator of the gaming venue was principally focused on reducing the exposure of a patron smoker using the gaming machine and had concerns that the quality of the filtered air was still not low enough (e.g.; in the absence of a established safe or de minimus level). the output flow could be directed away from the smoker, instead of toward the smoker.

Since the smoke removal system is associated with the gaming machine and the gaming machines typically contain sensitive apparatus, such as a semiconductor which can be sensitive to airborne particulates (e.g.; dust and cigarette smoke), care must be taken to minimize the migration of contaminant laden air into the areas of the gaming machine in which the sensitive apparatus is contained (e.g.; by designing and sealing the exhaust fan and its housing to minimize contaminant migrations). However, as noted above, because the heat generated by most computer circuits must be dissipated by circulating ambient air across the circuit, directing at least a portion of the filtered air into the wall of a housing containing an electronic circuit can also be used to cool the electronics, with a dedicated flow of cleaner air than would otherwise be drawn from the ambient air in the casino.

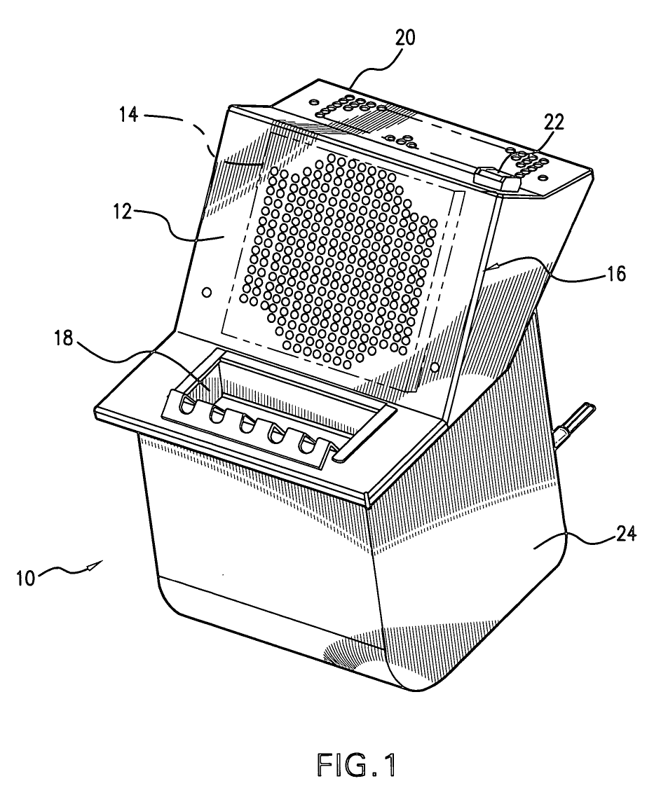

Several preferred example of the smoke removal systems of the present invention are shown in FIGS. 1-4.

As shown in the preferred embodiment depicted in FIG. 1, the smoke control system 10 (associated with a slot machine, not shown) which includes a smoke intake constituting the an inflow zone 12, with an exhaust fan 14 (not shown) behind the inflow zone 12, a replaceable filter 16 and a removal ashtray 18, with the fan having sufficient capacity to draw essentially all of the smoke from a lighted cigarette (not shown) in ashtray 18 directly into inflow zone 12. Filtered air after passing through filter 16 is discharged through outflow 20 which may be directed toward or away from a user of the slot machine. The smoke control system 10 is incorporated into the coin catch 24 portion of the slot machine and has a sensing means 22 to automatically actuate smoke control system 10 when the slot machine is in use. Alternatively, sensing means 22 could detect (e.g.; by pressure drop measurements) the buildup of contaminants on the filter 16 and warn the operator of the need to replace the filter and/or when the removable ashtray is near full and requires emptying. This embodiment is particularly desirable in that an existing portion of the front of a gaming machine designed for coin operation can be retrofitted at the time or after the machine is converted to coin-less operation, to beneficially incorporate the smoke removal system of the present invention.

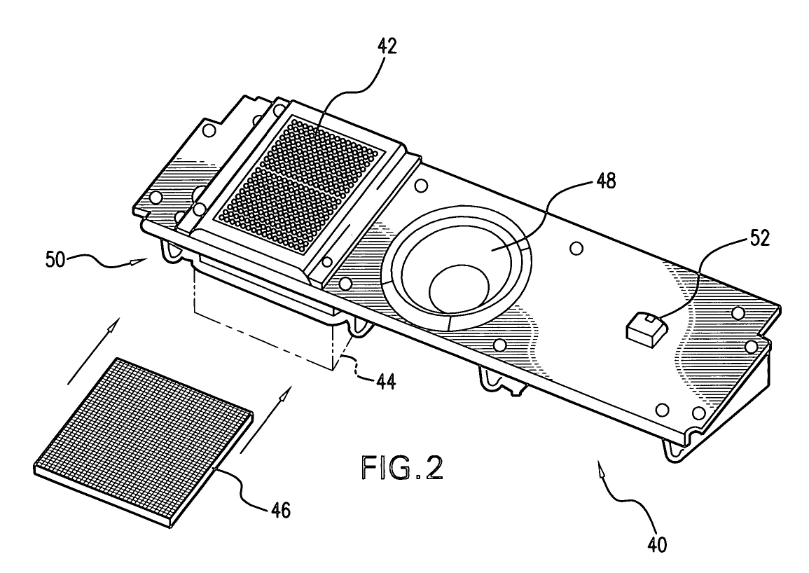

As shown in the preferred embodiment depicted in FIG. 2, the smoke control system 40 (associated with a slot machine, not shown) which includes a smoke intake constituting the an inflow zone 42, with an exhaust fan 44 (not shown) behind the inflow zone 42, a replaceable filter 46 and a removal ashtray 48, with the fan having sufficient capacity to draw essentially all of the smoke from a lighted cigarette (not shown) in ashtray 48 directly into inflow zone 42. Filtered air after passing through filter 46 is discharged through outflow 50 (not shown) which may be directed toward or away from a user of the slot machine, or into the gaming machine to provide internal cooling. The smoke control system 40 is incorporated into a coin tray (not shown) of the slot machine and has a sensing means 52 to automatically actuate smoke control system 40 when the slot machine is in use. Alternatively, sensing means 52 could detect (e.g.; by pressure drop measurements) the buildup of contaminants on the filter 46 and warn the operator of the need to replace the filter. This embodiment is also particularly desirable in that an existing portion of the front of a gaming machine designed for coin operation can be retrofitted at the time or after the machine is converted to coin-less operation, to beneficially incorporate the smoke removal system of the present invention.

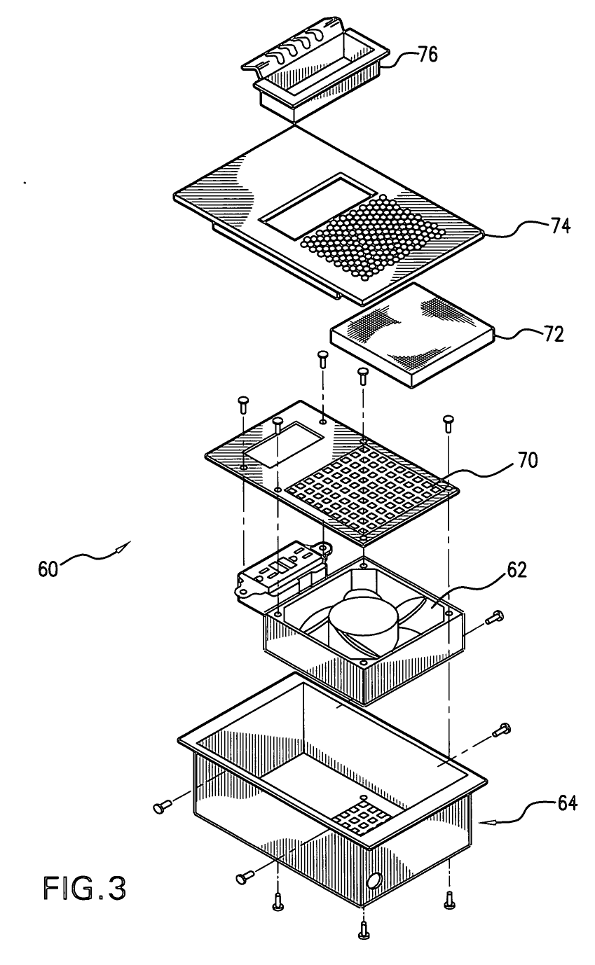

As shown in FIG. 3, a control system 60 similar (but not identical to that shown in FIG. 2) is depicted which shows the mounting of exhaust fan 62 in housing 64. Also shown is bottom plate 70, which supports filter 72 between it and top plate 74, which also supports ashtray 76.

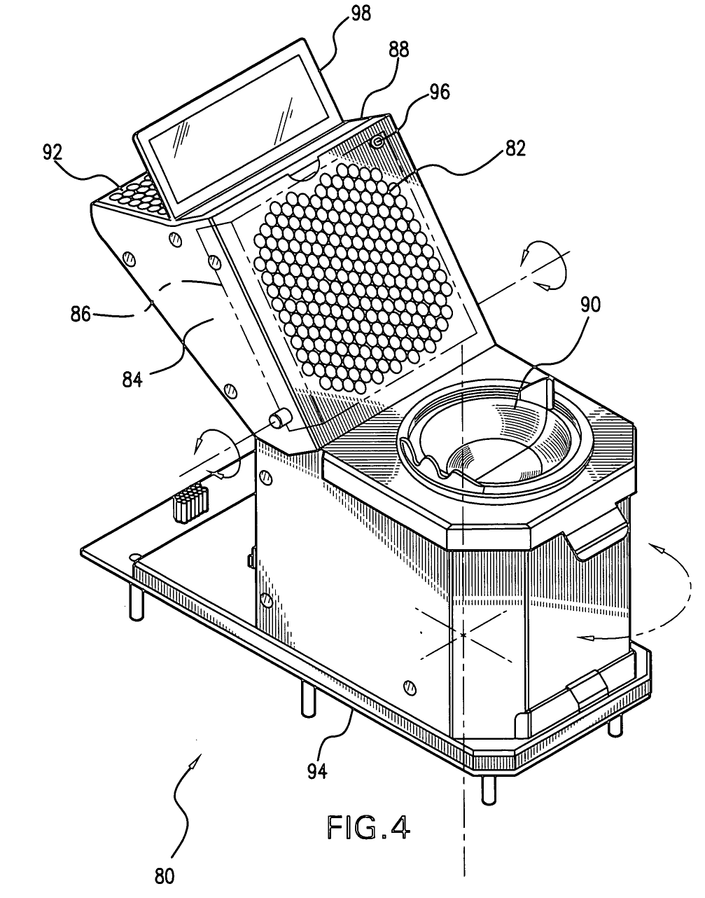

As shown in the preferred embodiment depicted in FIG. 4, the smoke control system 80 (associated with a slot machine, not shown) which includes a smoke intake constituting an inflow zone 82 which is a part of housing 84, with an exhaust fan 86 (not shown) behind the inflow zone 82, a replaceable filter 88 and a removal ashtray 90, with the fan having sufficient capacity to draw essentially all of the smoke from a lighted cigarette (not shown) in ashtray 90 directly into inflow zone 82. Housing 84 is optionally pivoted to allow the user to pivot housing 84 to face more upwardly or more downwardly (e.g.; to better focus on the user's smoke exhalation). Filtered air after passing through filter 88 is discharged through discharged an outflow 92 (not shown) which may be directed toward or away from a user of the slot machine. The smoke control system 80 can be installed as an attachment to the side of a gaming machine (by means not shown) or mounted on base 94 between two closely placed gaming machine to provide benefits to areas in front of one or both of the machines. Base 94 is also optionally pivoted to allow the user to pivot smoke control system 80 (e.g.; to more directly draw air contaminated from the front of the gaming machine), which would be particularly useful when the smoke control system 80 is positioned between there are two adjacently placed gaming machines and only one of the machines is being used by a smoker. The smoke control system 80 has an optional sensing means 96 to automatically actuate smoke control system 40 when the slot machine is in use. Alternatively, sensing means 96 could detect (e.g.; by pressure drop measurements) the buildup of contaminants on the filter 46 and warn the operator of the need to replace the filter. This embodiment is also shown with an optional LCD screen 98, which would facilitate the presentation of commercial or health-related text or video, through means not shown.

Obviously many other modifications, variations and applications of the present invention are possible in the light of the above teachings. It is to be understood, therefore, that within the scope of the appended claims, the invention may be practiced otherwise than as specifically described.

What is claimed is:

1. A system for controlling tobacco smoke in association with a gaming machines by exhausting contaminated air from the ambient air in front of said gaming machine which is typically occupied by a user of the gaming machine and an ash tray for lighted cigarettes comprising: (1) an exhaust fan having filtering means and functionally associated with said gaming machine, (2) an inflow zone allowing ambient air adjacent to the front of the gaming machine to pass into said exhaust fan, (3) an outflow zone through which air filtered through said filtering means is passed, (4) one or more sensing means for detecting when the gaming machine is in use and (5) means for automatically activating said exhaust fan in response to a signal indicating use from said detecting device that the gaming machine is in use.

2. The system of claim 1 wherein said gaming machine is a slot machine.

3. The system of claim 2 wherein said filtering means is a multi-layer filter including at least one electrostatic filter within the exhaust fan and at least one fibrous filter.

4. The system of claim 2 wherein said detecting means is selected from the group consisting of motion detectors and smoke detectors and further comprising one or more sensing means to detect conditions of the system selected from the group consisting of filter condition and ashtray load.

5. The system of claim 2 wherein said means for automatically activating said exhaust fan is an electrical switch which is automatically switched on when said detecting means indicates said gaming machine is in use.

6. The system of claim 2 wherein said gaming machine is designed to include a coin tray and said exhaust fan is incorporated within the front of said gaming machine otherwise occupied by said coin tray.

7. A method of controlling tobacco smoke in association with a gaming machine in the region surrounding the gaming machine in which a player would be present comprising: (1) automatically actuating an exhaust fan functionally associated the gaming machine when said gaming machine is in use, (2) withdrawing air from a region surrounding the gaming machine through a filter within the exhaust fan; and (3) exhausting said air after passage through said filter.

8. The method of claim 7 wherein the exhausting of the filtered air is into and through the interior of the gaming machine to provide cooling of the interior of the device.

9. The method of claim 7 wherein the automatically actuating step of an exhaust fan is by electrically activating the said fan in response to the initiation of use of the gaming machine by a player.

10. The method of claim 5 wherein the gaming machine is a slot machine.

11. A system for controlling tobacco smoke in association with a gaming machine comprising: (1) an exhaust fan having (i) an inflow zone for exhausting air from a region typically occupied by a user of said gaming machine and (ii) an outflow zone, (2) an ashtray region which is sufficiently close to said inflow zone to allow a substantial portion of smoke emanating from a burning cigarette placed in said ashtray region to flow directly into said inflow zone and (3) filtering means between said inflow zone and said outflow zone.

12. The system of claim 11 wherein said gaming machine is a slot machine and the outflow zone directs flow of filtered air away from the said user.

13. The system of claim 11 wherein the smoke control system is mechanically incorporated into the gaming machine.

14. The system of claim 11 wherein said inflow zone is appropriately spatially positioned in such close proximity to said gaming machine so that smoke from the region in which smoke is produced by a smoker using said gaming machine can be effectively drawn into the smoke control system.

15. The system of claim 11 wherein said filtering means is a multi-layer filter including at least one electrostatic filter and at least one fibrous filter.

16. The system of claim 11 further comprising (1) means for automatically activating said exhaust fan in response to a signal from said detecting device indicating that the gaming machine is in use and (2) one or more sensing means to detect conditions of the system selected from the group consisting of filter condition and ashtray load.

17. The system of claim 11 wherein the gaming machine is functionally connected to said outflow zone by a conduit carrying filtered air from said outflow zone into the interior of the gaming machine to provide cooling.

18. The system of claim 11 wherein the an exhaust fan is pivotally mounted to allow for adjustment of the position of said inflow zone with respect to the position of the said region occupied by a user of said gaming machine.

19. The system of claim 11 further comprising a sensing device to detect the need for maintenance of said filtering means.

20. The system of claim 11 further comprising a video screen mounted on the exhaust.
